(19) United States
(12) Patent Application Publication
(10) Pub. No.: US 2005/0250875 A1
(43) Pub. Date: Nov. 10, 2005

(54) Pigment compositions for oil-based lithographic printing inks

(76) Inventors: Alastair McAlpine Marr, Paisley (GB); David Allan Williamson, Renfrew (GB); Edward James Anderson, Kilbarchan (GB)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/527,609

(22) PCT Filed: Sep. 18, 2003
(86) PCT No.: PCT/EP03/10394

§ 371 Date: Mar. 11, 2005

(30) Foreign Application Priority Data
Sep. 26, 2002 (EP) 02405831.5

(51) Int. Cl. C03C 17/00; C09D 11/00

(52) U.S. Cl. 523/160; 523/161

(57) ABSTRACT

Pigment compositions suitable for oil-based lithographic printing inks are provided which comprise besides an organic pigment, a hyperdispersant which is a poly-alkyleneiminepolyester adduct, a synergist agent which is a quaternary ammonium pigment derivative, a solvent which includes aliphatic/aromatic hydrocarbon distillates and vegetable oils, and optionally rosin or a modified rosin. The printing inks prepared from these pigment compositions show outstanding improvements in their rheological properties.

The present invention relates to pigment compositions suitable for use in oil-based lithographic printing inks. More particularly, the invention relates to pigment compositions containing besides the pigment a combination of additives comprising a synergist component and a polymeric hyperdispersant, dissolved in a solvent which is a hydrocarbon distillate fraction or a vegetable oil.

Lithographic printing is a process which utilizes a coated metal or polymeric plate containing a hydrophobic image area which accepts hydrophobic based ink and a non-image hydrophilic area which accepts water, i.e. the fount(ain) solution.

Many oil-based inks, especially vegetable oil-based lithographic printing inks, are prone to an uptake of fount solution in areas of shear, e.g. at the ink/fount contact where the ink duct rollers meet the founted press drum. This intimate contact of the fount solution and the ink causes an emulsification and the thus emulsified ink can “hang back” due to a high viscosity when emulsified. In extreme cases the ink will cease to flow onto the printing press. It is known that pigment compositions have a significant effect on this hang back phenomenon.

It has now been found that these problems can be overcome and outstanding effects can be achieved when using the new organic pigment compositions hereinafter described which comprise a particular combination of additives for the preparation of oil-based lithographic printing inks.

Accordingly it is the main object of the present invention to provide said new pigment compositions. Other objects of the present invention relate to processes to prepare said compositions, to prepare printing inks from said compositions and to use the inks in lithographic printing processes. These and other objects of the present invention will be described in the following.

Therefore, in a first aspect of the present invention, there is provided a pigment composition comprising
(a) 60 to 90% of an organic pigment,
(b) 1 to 10% of a hyperdispersant,
(c) 1 to 10% of a synergist agent (additive),
(d) 1 to 10% of a solvent, and
(e) 0 to 40% of rosin or a modified rosin.

Preferred are e.g. the following percentage ranges: 60 to 80% of component (a), 2 to 6% of component (b), 2 to 6% of component (c), 3 to 8% of component (d), and 2 to 30% of component (e).

All percentages are by weight.

The pigments of component (a) are those producing the four colours commonly used in the printing industry: namely black, cyan (blue), magenta (red) and yellow. As a rule, they are compatible with the other components of the inventive pigment compositions which constitute the basis (colourant) for forming the oil-based printing inks for lithographic printing processes, which are another object of the present invention.

Organic pigments as component (a) comprise such as, but not exclusively, monoazo, disazo, azomethin, azocondensation, metal-complex azo, naphthol, metal complexes, such as phthalocyanines, dioxazone, nitro, perinone, quinoline, anthraquinone, hydroxyanthraquinone, aminoanthraquinone, benzimidazolone, isoindoline, isoindolinone, quinacridone, anthrapyrimidine, indanthrone, flavanthrone, pyranthrone, anthanthrone, isoviolanthrone, diketopyrrolopyrrole, carbazole, perylene, indigo or thioindigo pigments. Mixures of the pigments may also be used.

The disazo pigments of component (a) represent an important class of colouring materials (colourants) used commonly for the manufacture of printing inks. Preferably they are yellow and orange diarylide pigments and orange disazopyrazolone pigments, including e.g. the C.I. Pigment Yellows 12, 13, 14, 17, 83, 174 and 188, as well as the C.I. Pigment Oranges 13, 16 and 34 which are often used as shading agents. Further preferred are metal complexes, such as copper phthalocyanine pigments (e.g. C.I. Pigment Blue 15:3), or naphthol pigments, preferably β-naphthol or β-oxynaphthoic acid (BONA) pigments (e.g. C.I. Pigment Red 57:1).

For further details as to all these organic pigments reference is made to Industrial Organic Pigments, W. Herbst, K. Hunger, 2^{nd} edition, VCH Verlagsgesellschaft, Weinheim, 1997. The so-called hyperdispersants of component (b) are e.g. reaction products of a poly(lower alkylene)-imine with a polyester having a free carboxylic acid group, in which there are at least two polyester chains attached to each poly(lower alkylene)-imine.

The reaction product may be a salt or an amide depending on the severity of the reaction conditions under which the polyester is reacted with the poly(lower alkylene)-imine.

A preferred polyester is derived from a hydroxycarboxylic acid of the formula OH—X—COOH, wherein X is a divalent saturated or unsaturated aliphatic radical containing at least 8 carbon atoms, preferably 12 to 20 carbon atoms, and in which there are at least 4, preferably 8 to 14 carbon atoms between the carboxylic and the hydroxy groups.

As specific examples of such hydroxycarboxylic acids there may be mentioned ricinoleic acid, a mixture of 9- and 1-hydroxystearic acids, and 12-hydroxystearic acid, and especially the commercially available hydrogenated castor oil fatty acid which contains in addition to 12-hydroxystearic acid minor amounts of stearic acid and palmitic acid.

The polyester can for example be obtained by heating the hydroxycarboxylic acid or a mixture thereof, optionally in the presence of an esterification catalyst, at a temperature in the region of about 160 to 200° C.

The term lower alkylene refers to alkylene groups containg 2 to 4 carbon atoms and the preferred poly(lower alkylene)-imine is polyethylene imine whose molecular weight range is generally from 500 to 100'000, preferably from 10'000 to 100'000.

Further details and examples of component (b) are disclosed in GB 2'001'083, the substance of which is Incorporated herein by reference.

The so-called synergistic additive (agent) of component (c) is for example an asymmetric disazo compound comprising a central divalent group, free from ionic substituents, linked through azo groups to two monovalent end groups, the first being free from any ionic groups and the second being a single substituted ammonium salt group.

The central divalent group of the asymmetric compound is preferably a biphenylene group which may be unsubstituted or substitued by one or more non-ionic groups selected from lower alkyl, lower alkoxy (lower means C₁₋₄), halogen (chloro), nitro and cyano.

The first end group of the asymmetric compound, which is free from ionic substituents, is preferably a pyrazolin-5-on-4-yl, a 2-hydroxynaphth-1-yl or an acetoacet-2-ylanilide group, such groups being typically present in disazo pigments. They may carry substituents such as lower alkyl, lower alkoxy, halogen, nitro, cyano, lower alkoxy-carbonyl, phenylaminocarbonyl, naphthylaminocarbonyl and phenyl, in which the phenyl and naphthyl groups are optionally substituted by lower alkyl, lower alkoxy, halogen, nitro or cyano.

The second end group of the asymmetric compound, carrying the salt group, may be otherwise identical to the first end group or may be selected from the first end groups defined above with the addition of the salt group. The second end group is preferably an acetoacet-1-ylanilide group in which the salt group is in the 4-position on the benzene ring with respect to the amino group, a 1-phenylpyrazolin-5-on-4-yl group in which the salt group is in the 4-position on phenyl, or a 2-naphth-1-yl group in which the salt group is in the 6-position of the naphthalene ring.

The substituted ammonium-acid salt group is preferably a substituted ammonium carboxylate or phosphonate group or especially a substituted ammonium sulfonate group. The substituted ammonium-acid salt group preferably contains at least one fatty aliphatic group attached to the nitrogen atom of the ammonium ion. The substituted ammonium ion contains—as a rule—at least 6, preferably at least 12, and more preferably from 16 to 80, carbon atoms in from 1 to 4 aliphatic groups. In a particular useful agent the ammonium ion has 3 or 4 aliphatic groups containing in total from 16 to 60 and more preferbly from 25 to 40 carbon atoms. It is also preferred that at least one of the aliphatic groups contains 8 to 20, especially preferred 26 to 20 carbon atoms.

Examples of the substituted ammonium compounds, e.g. halides and hydroxides, which may be used to prepare component (c) are tallow benzyl dimethyl ammonium chloride, ditallow dimethyl ammonium chloride, ditallow benzyl methyl ammonium chloride, coco benzyl dimethyl ammonium chloride and dicoco dimethyl ammonium chloride.

Further details and examples of component (c) are disclosed in EP 0 076 024, the substance of which is incorporated herein by reference.

Component (d) constitutes a solvent (ink vehicle) which may be a so-called mineral oil solvent which comprises aliphatic or aromatic hydrocarbon distillate fractions of boiling points of from 100 to 350° C., preferably of from 180 to 300° C., or vegetable oils.

The vegetable oils for use in the printing ink vehicles of the invention are the commonly available vegetable triglycerides in which the fatty acid moieties have a chain length of about 12 to 24 carbon atoms, preferably of 18 to 22 carbon atoms. Of particular interest are those which have a substantial proportion of diunsaturated linoleic fatty add and triunsaturated linolenic fatty acid moieties, e.g. soybean, coconut, cottonseed, linseed, safflower, sunflower, corn, sesame, rapeseed and peanut oil or mixtures thereof.

Though the aforementioned oils can be employed in the crude state as originally expressed from the seed material, there are advantages to subjecting them to certain preliminary processing steps. For example, alkali refining removes the gums and phospholipids which may interfere with the properties of the vehicles and the ultimate ink formulations. Alkali refining also removes free fatty acids, which tend to reduce hydrophobicity properties in ink formulations.

The hydrocarbon distillate fractions as component (d) are preferred, but vegetable oils are also important.

Component (d) may be added separately to the inventive pigment compositions, but preferably it may be added together with component (b), i.e. as a solution of component (b) in component (d).

The optional component (e) includes—but is not limited to—rosin (abietic acid), rosin (acid) salts, such as alkali metal salts (sodium, potassium), and modified rosins such as rosin (acid) metal resinates (copper, zinc, magnesium resinates), rosin esters, such as maleinized rosin, pentaerythritol rosin or rosin-modified phenolic resins, and further vegetable oil based rosin esters, such as soybean or tall oil esters (methyl, butyl), and further hydrogenated rosins, disproportionated rosins, dimerised, polymerised and part-polymerised rosins (rosins, cross-linked with e.g. formalsehyde), or mixtures thereof. These compounds and their use in printing compositions are well known in the art.

The pigments of the inventive pigment compositions may be prepared by following processes including various conventional steps well known in the art; components (b), (c), (d) and optionally (e) may be added during these steps to prepare the inventive pigment compositions.

Alternative methods that may be used are e.g.:
(I) straight addition of the components during any of the conventional steps;
(II) emulsification with water using a suitable surfactant;
(III) emulsification with a micellar resin soap solution;
(IV) separate addition of a water-soluble carrier solution of component (b), followed by a separate addition of the other components (in any of steps (I) to (III) inclusive)

The synergist additive (c) can also be added as a dry blend to the pigment powder during the milling step in the pigment preparation.

The inventive pigment composition may be used to prepare oil-based printing inks for lithographic printing processes. As a rule, such an ink contains about 5 to 50% by weight of the pigment composition.

Furthermore, the lithographic printing inks may in addition comprise customary additives known to those skilled in the art.

Typical additives include drying enhancers, drying inhibitors, non-coloured extenders, fillers, opacifiers, antioxidants, waxes, oils, surfactants, rheology modifiers, wetting agents, dispersion stabilizers, strike-through inhibitors and anti-foaming agents; further adherence promoters, cross-linking agents, plasticisers, photinitiators, deodorants, biocides, laking agents and chelating agents.

Such additives are usually used in amounts of from 0 to 5% by weight, particularly from 0 to 2% by weight, and preferably from 0.01 to 1% by weight, based on the total weight of the lithographic printing ink composition.

The inks and the printing processes are further objects of the present invention.

The inventive pigment composition is dispersed into the lithographic printing ink system, which is preferably a vegetable oil system, by conventional means, e.g. by premixing, then beadmilling using either a horizontal or vertical beadmill or by premixing of the pigment into the varnish followed by dispersion on a three-roll mill.

The millbases is usually let-down with more varnish components and wax additives to adjust the final ink properties, such as a distinct rheological behaviour (flow) and tackiness.

The inventive printing ink can be used on a lithographic printing press whereby it is passed from a reservoir by means of a roller duct system to the inking plate. This plate is pre-treated with aqueous fount solution often containing alcoholic components to aid the lithographic process. At the interface of the ink duct roller and inking roller the fount solution becomes intimately contacted with the ink causing an emulsification. In extreme cases the ink will cease to flow and “hang back” because the water increases the complex viscosity of the ink too much. The inventive printing inks overcome this drawback by reducing the complex viscosity of the ink when the fount (solution) is emulsified in the ink and thus the ink continues to flow onto the press in an appropriate and effective manner.

The inventive printing inks produce the desired Theological properties in all types of lithographic printing inks know in the art, e.g. heatset, sheetfed or coldset printing inks based on aromatic and preferably aliphatic hydrocarbon distillates or vegetable oils. The vegetable oils, such as preferably linseed or soybean oil, but also alkylesters (methyl, butyl) of tall oil rosins, are preferred over the distillates. These systems are more polar in nature and are therefore more susceptible to the uptake of water in emulsified form, particularly when there is an alcoholic component present in the fount solution.

It is the particular combination of components (b), (c) and (d) (and optionally (e)) of the inventive pigment composition which is responsible for and achieves the advantageous effects of the inventive lithographic printing inks with regard to their Theological properties (good wet and dry flow). Optionally, the wet flow advantage can be achieved already by the combination of components (b) and (d), and the dry flow advantage by component (c), alone.

The present invention is hereinafter further described with reference to particular examples thereof. It will be appreciated that these examples are presented for illustrative purposes and should not be construed as a limitation of the scope of the invention as herein described.

In the following examples, quantities are expressed as part by weight or percent by weight, if not otherwise indicated. The temperatures are indicated in degrees centigrade.

### EXAMPLES

### Example 1

General manufacturing instruction (1): A diarylide yellow pigment (C.I. Pigment Yellow 13, C.I. No. 21100) is prepared by coupling an aceto-acetyl compound (aceto-acet-2,4-xylidene) by forming a basic solution thereof followed by re-precipitation of the free acid form of the aceto-acet compound by the addition of a mixture of acetic and hydrochloric acid. This ‘seeded’ coupling component has a solution of tetrazotised 3,3′-dichlorobenzidine added over about 1 hour at 15 to 20° C. and a pH-value of 4.5 to 6.0.

The tetrazotised 3,3′-dichlorobenzidine is prepared by the addition of excess hydrochloric acid and sodium nitrite solution to an aqueous slurry of 3,3′-dichlorobenzidine dihydrochloride at 0 to 10° C.

The resultant amorphous pigment is then treated with a rosin (acid) sodium salt and a 40% solution of the copolymer of poly-(12-hydroxy stearic acid) (hyperdispersant, component (b)) in an (aromatic free) distillate of a boiling point range of 240 to 260° C.

The resultant slurry is heated to 90-93° C. by the addition of direct steam, and then the pH is slowly adjusted to 5. The slurry is flushed back to 70° C. and then an aqueous slurry of a synergist additive (quaternary ammonium pigment derivative, component (c)) is added and stirred out.

The slurry is then filtered, washed and dried until the moisture and residual salt contents are both less than 1% by weight, respectively. The pigment retains the added components quantitatively after said washing and drying steps.

Component (b):

Copolymer of polyethylene imine (molecular weight of about 50'000) and poly-(12-hydroxy stearic acid (obtained by heating 12-hydroxystearic acid for about 20 hours a 190-200° C.)

Component (c):

Coupling of an equimolar mixture of acetoacetanilide and acetoacetanilide-4-sulphonic acid (potassium salt) with tetrazotised 3,3′-dichlorobenzidine. The resultant (yellow) compound is ion-paired with dihydrogenated tallowdimethyl ammonium chloride.

According to the general manufacturing instruction the following pigment composition is prepared.

According to the Present Invention:

| | |
|---|---|
| C.I.Pigment Yellow 13 (component (a)) | 65.0% |
| Copolymer (component (b)) | 3.0%¹⁾ |
| Synergist additive (component (c)) | 3.0% |
| Aromatic-free distillate (component (d)) | 4.0%¹⁾ (boiling point: |
| | 240-260° C.) |
| Rosin (acid) (component (e)) | 25.0% |

¹⁾combined 40:60

### Comparative Example 1A

| | |
|---|---|
| C.I. Pigment Yellow 13 (component (a)) | 70.0% |
| Rosin (acid) (component (e)) | 30.0% |

This pigment composition is then dispersed into a lithographic printing ink system (percentage of the composition present in the ink system: 5 to 50%) by conventional means (milling). The ink shows excellent rheological properties, especially in regard to duct flow of the dry ink and hang back of the wet ink.

The inks are tested for their low shear flow properties as correlation with their flow properties on a lithographic printing press. The low shear flow performance correlating with the ink's duct flow and hangback performance when considered as dry ink in the first case and wet or emulsified ink in the second case (“inclined plate test”).

| | |
|---|---|
| Duct Flow of Dry Ink: | |
| Example 1 (invention): | 6.6 cm |
| Example 1A (comparison): | 3.2 cm |
| Hang Back of the Wet Ink: | |
| Example 1 (invention): | 4.5 cm |
| Example 1A (comparison): | 2.1 cm |

### Example 2

General Manufacturing Instruction (2):

A copper phthalocyanine pigment (C.I. Pigment Blue 15:3, C.I. No. 74160, Component (a)) is prepared by reaction of phthalic anhydride, urea and a copper source such as CuCl₂ in the presence of an aromatic solvent (i.e. o-nitrotoluene) and a molybdate catalyst under increased temperature and pressure. The resultant so-called crude copper phthalocyanine (i.e. having crystals of −200 μm and >90% β-phase) is then subjected to dry milling (i.e. ball milling) in the presence of an inorganic salt such as NaCl along with wood rosin (Component (e)). The milled intermediate, containing ˜50% β-phase, is then solvent conditioned in a basic (pH>11) solution containing an organic solvent such as n-butanol at elevated temperature until a pigmentary (i.e. <10 μm) copper phthalocyanine composition containing >90% β-phase is obtained. The pigment is then filtered and washed solvent and salt free (<300 μS conductivity) and retained as a 46.4% solids aqueous press cake.

The press cake is then re-dispersed in water an treated with a rosin acid salt (Component (e′)) and a 40% solution of the co-polymer of poly-(12-hydroxystearic acid) (hyperdispersant, Component (b)) in an (aromatic free) petroleum distillate (Component (d)). The resultant slurry is heated to 90° C. using e.g. a water bath and stirred mechanically for 60 minutes before being treated with a quaternary ammonium pigment derivative (synergist, Component (c)) and cooled immediately using no artificial means. Once below 35° C., the slurry is acidified (pH<1) using concentrated HCl and finally stirred out.

The pigment slurry is then filtered, washed acid and salt free (<300 μS conductivity) and dried at 70-80° C. The pigment retains components (a)-(e′) after the washing/drying steps.

Modified General General Manufacturing Instruction (2.1):

A copper phthalocyanine pigment (C.I. Pigment Blue 15:3, Component (a)) is prepared by dry-milling crude Copper Phthalocyanine in the presence of an inorganic salt such as NaCl and wood rosin (Component (e)), followed by a solvent conditioning stage which is carried out in an aqueous solution containing an organic solvent. The resulting presscake from this preparation is then re-dispersed in water and treated with a rosin acid salt (Component (e′)) and a 40% solution of the co-polymer of poly-(12-hydroxystearic acid) (hyperdispersant, Component (b)) in an (aromatic free) petroleum distillate (Component (d)). The resultant slurry is heated to 90° C. using e.g. a water bath and stirred mechanically for 60 minutes before being treated with a quaternary ammonium pigment derivative (synergist, Component (c)) and cooled immediately using no artificial means. Once below 35° C., the slurry is acidified (pH<1) using concentrated HCl and finally stirred out.

The pigment slurry is then filtered, washed acid and salt free (<300 μS conductivity) and dried at 70-80° C. The pigment retains components (a)-(e′) after the washing/drying steps.

Component (a):

Pigmentary copper phthalocyanine, C.I. Pigment Blue 15:3
   Component (e):
Partially hydrogenated wood rosin (Staybelite®)
   Component (e′):
Disproportionated wood rosin, potassium salt (Burez®)
   Component (b):
Copolymer of polyethylene imine (MW ˜50,000) and poly-(12-hydroxystearic acid) (Solsperse® 13,000)
   Component (d):
Aromatic free petroleum distillate having a boiling range of 240-270° C.
   Component (c):
Dihydrogenated tallow dimethyl ammonium chloride ion-paired with copper phthalocyanine mono-sulphonic acid (Solsperse® 5000)

According to the general manufacturing instructions outlined above, the following pigment preparations are prepared.

According to the Present Invention:

| | |
|---|---|
| C.I. Pigment 15:3 (component (a)) | 80.0% |
| Rosin 1 (component (e)) | 2.3% |
| Rosin 2 (component (e′)) | 3.3% |
| Hyperdispersant (component (b)) | 4.1% |
| Distillate (component (d)) | 6.2% |
| Synergist (component (c)) | 4.1% |

### Comparative Example 2A

| | |
|---|---|
| C.I. Pigment 15:3 (component (a)) | 80.0% |
| Rosin 1 (component (e)) | 2.3% |
| Rosin 2 (component (e′)) | 17.7% |

The pigment compositions are then dispersed into a lithographic ink system (percentage of the compositions in the ink system: 5-50%) by conventional means (triple roll milling). The ink obtained in example 2 shows excellent rheological properties, especially in regard to duct flow of the dry ink and hang back of the wet ink compared with comparative example 2A.

Duct Flow of Dry Ink:

| | |
|---|---|
| Example 2 (invention): | 10.5 cm |
| Example 2A (comparison): | 7.5 cm |

Hang Back of the Wet Ink:

| | |
|---|---|
| Example 2 (invention): | 14.2 cm |
| Example 2A (comparison): | 6.5 cm |

### Example 3

General manufacturing instruction (3): A Ca4B pigment (C.I. Pigment Red 57:1, C.I. No. 15850) is prepared by coupling beta-hydroxynaphthoic acid by forming a basic solution thereof followed by addition of a rosin (acid) sodium salt and a 40% solution of the copolymer of polyethylene imine (MW ˜50,000 and poly-(12-hydroxystearic acid) (hyperdispersant, component (b)) in an (aromatic free) distillate of a boiling point range of 240 to 260 degrees C. This mixture and a slurry of diazotised 4-aminotoluene-3-sulphonic acid are added together into the coupling vessel over about 23 minutes at 8 to 10 degrees C. and a pH value of 10.8 to 11.0. The diazotised 4-aminotoluene-3-sulphonic acid is prepared by the addition of excess hydrochloric acid and sodium nitrite solution to basic aqueous solution of 4-aminotoluene-3-sulphonic acid at 0 to 10 degrees C.

The pH of the resultant slurry is slowly adjusted to 7.2 and then heated to 90 degrees C. by the addition of direct steam. After being held at this temperature for 15 minutes, the slurry is flushed back to 70 degrees C. and then a synergist additive (quaternary ammonium pigment derivative, component (c)) is added and stirred out.

The slurry is then filtered, washed and dried until the moisture and residual salt contents are both less than 1% by weight, respectively. The pigment retains the added components quantitatively after said washing and drying steps.

Component (b):

as described in Example 1.

Component (c):

Coupling of an equimolar mixture of beta-naphthol and beta-naphthol-6-sulphonic acid (potassium salt) with tetrazotised 3,3′-dichlorobenzidine. The resultant (red) compound is ion-paired with dihydrogenated tallowdimethyl ammonium chloride.

The following pigment compositions are prepared:

According to the Present Invention:

| | |
|---|---|
| C.I.Pigment Red 57:1 (component (a)) | 67.1% |
| Copolymer (component (b)) | 5.3% |
| Synergist additive (component (c)) | 3.9% |
| Aromatic-free distillate (component (d)) | 7.9% |
| Rosin (acid) (component (e)) | 15.8% |

### Comparative Example 3A

| | |
|---|---|
| C.I. Pigment Red 57:1 (component (a)) | 70.0% |
| Rosin (acid) (component (e)) | 30.0% |

This pigment compositions are then dispersed into a lithographic printing ink system (percentage of the composition present In the ink system: 5 to 50%) by conventional means (milling). The ink obtained in example 3 shows excellent rheological properties, especially in regard to duct flow of the dry ink and hang back of the wet ink when compared to comparative example 3A.

| Duct Flow of Dry Ink: | | |
|---|---|---|
| Example 3 (invention): | 18 | cm |
| Example 3A (comparison): | 13 | cm |
| Hang Back of the Wet Ink: | | |
| Example 3 (invention): | 14 | cm |
| Example 3A (comparison): | 11.5 | cm |

1. A pigment composition comprising
(a) 60 to 90% of an organic pigment,
(b) 1 to 10% of a hyperdispersant,
(c) 1 to 10% of a synergist additive,
(d) 1 to 10% of a solvent, and
(e) 0 to 40% of rosin or a modified rosin.

2. The pigment composition according to claim 1, wherein the organic pigment (a) is a disazo pigment, a metal complex pigment, or a naphthol pigment.

3. The pigment composition according to claim 1, wherein the hyperdispersant (b) is a reaction product of a poly(lower alkylene)-imine with a polyester having a free carboxylic acid group, in which there are at least two polyester chains attached to each poly(lower alkylene)-imine.

4. The pigment composition according to claim 3, wherein the hyperdispersant (b) is a reaction product of poyethyleneimine of a molecular weight range of 500 to 100'000 with a polyester derived from a hydroxycarboxylic acid of the formula HO—X—COOH, wherein X is a divalent saturated or unsaturated aliphatic radical contaning at least 8 carbon atoms, and in which there are at least 4 carbon atoms between the carboxylic and the hydroxy groups.

5. The pigment composition according to claim 1, wherein the synergistic additive (c) is an asymmetric disazo compound comprising a central divalent group, free from ionic substituents, linked through azo groups to two monovalent end groups, the first being free from any ionic groups and the second being a single substituted ammonium salt group.

6. The pigment composition according to claim 1, wherein the solvent (d) is an aliphatic or aromatic hydrocarbon distillate fraction of boiling points of the range of 100 to 350° C. or a vegetable oil.

7. The pigment composition according to claim 6, wherein the vegetable oil is a triglyceride in which the fatty acid moieties have a chain length of 12 to 24 carbon atoms.

8. The pigment composition according to claim 1, wherein the modified rosin (e) is a rosin (acid) metal resinate, a rosin ester, a pentaerythritol rosin and a rosin-modified phenolic resin, a vegetable oil based rosin ester, a hydrogenated rosin, a disproportionated rosin, or a dimerised, polymerised or part-polymerised rosin, or mixtures thereof.

9. An oil-based printing ink for lithographic printing containing as colourant a pigment composition acording to claim 1.

10. The printing ink according to claim 9 containing as colourant 5 to 50% of the pigment composition, and optionally further customary additives.

11. A process for preparing the printing ink according to claim 9 which comprises dispersing the pigment composition into a lithographic printing ink system.

12. A process for preparing the printing ink according to claim 10 which comprises dispersing the pigment composition into a lithographic printing ink system.

13. The pigment composition according to claim 2, wherein the disazo pigment is a diarylide pigment.
